(19) United States
(12) Patent Application Publication
(10) Pub. No.: US 2026/0097360 A1
(43) Pub. Date: Apr. 9, 2026

(54) METHODS AND SYSTEMS FOR COLLABORATIVE PREDICTION AND INTELLIGENT CONTROL OF MULTIPLE POLLUTANTS IN WASTE INCINERATION FLUE GAS

(71) Applicant: ZHEJIANG UNIVERSITY, Hangzhou (CN)

(72) Inventors: Xiaoqing LIN, Hangzhou (CN); Ren WANG, Hangzhou (CN); Jie CHEN, Hangzhou (CN); Qunxing HUANG, Hangzhou (CN); Xiaodong LI, Hangzhou (CN); Jianhua YAN, Hangzhou (CN)

(73) Assignee: ZHEJIANG UNIVERSITY, Hangzhou (CN)

(21) Appl. No.: 19/346,376

(22) Filed: Sep. 30, 2025

(30) Foreign Application Priority Data
Oct. 6, 2024 (CN) 202411387636.6

(51) Int. Cl. B01D 53/34; B01D 53/14; B01D 53/18; B01D 53/50; B01D 53/56; B01D 53/68; B01D 53/78; G06N 5/022

(52) U.S. Cl. CPC B01D 53/346; B01D 53/1412; B01D 53/1481; B01D 53/1493; B01D 53/18; B01D 53/502; B01D 53/56; B01D 53/68; B01D 53/78; G06N 5/022; B01D 2251/304; B01D 2251/404; B01D 2251/604; B01D 2252/102; B01D 2253/102; B01D 2257/204; B01D 2257/302; B01D 2257/404; B01D 2258/0291

(57) ABSTRACT

A method and a system for collaborative prediction and intelligent control of multiple pollutants in waste incineration flue gas are provided. The method includes: constructing a multi-pollutant collaborative prediction model for four types of flue gas pollutants in waste incineration flue gas based on a deep learning algorithm; constructing a cost index function considering an absorbent dosage and an environmental protection index function considering pollutant emission amounts by integrating multi-objective optimization methods; determining optimal dosage data of absorbents corresponding to the four types of flue gas pollutants; controlling and adjusting an opening degree of the dispensing valve of the each absorbent based on the optimal dosage data, thereby achieving intelligent control of multiple pollutants in waste incineration flue gas.

### CROSS-REFERENCE TO RELATED APPLICATIONS

This application claims priority to the Chinese Patent Application No. 202411387636.6, filed on Oct. 6, 2024, the contents of which are hereby incorporated by reference.

### TECHNICAL FIELD

The present disclosure relates to the field of pollutant control in waste incineration flue gas, and in particular, relates to a method and a system for collaborative prediction and intelligent control of multiple pollutants in waste incineration flue gas.

### BACKGROUND

Waste incineration, with significant advantages including harmlessness, reduction in volume, and resource utilization, has become a mainstream manner for domestic waste disposal at this stage. However, due to the complex composition of the waste, the flue gas after waste incineration contains various pollutants, such as hydrogen chloride (HCl), sulfur dioxide (SO₂), nitrogen oxides (NOₓ), and particulate matter (PM). The emission of these pollutants can easily harm the environment and human health. Consequently, waste incineration plants require substantial investment for pollutant emission control.

Understanding the concentration levels of pollutants in waste incineration flue gas is crucial for achieving ultra-low emissions. Currently, waste incineration plants primarily utilize a continuous emission monitoring system (CEMS) to monitor the emissions of criteria pollutants such as NOₓ in the flue gas. However, CEMS monitoring results are susceptible to environmental influences and may exhibit certain measurement delays. Additionally, CEMS equipment entails relatively high maintenance costs.

In recent years, data-driven machine learning models have been increasingly applied to predict flue gas pollutant concentrations. For example, Chinese patent applications “Prediction system and method for NOₓ emission from circulating fluidized bed domestic waste incineration boilers” (CN106931453A) and “Data-driven method for predicting WFGD outlet SO₂ concentration and intelligent optimization” (CN115309117A) propose using BP neural network and artificial neural networks, respectively, to predict the concentrations of NOₓ and SO₂ in boiler flue gas. However, due to various factors such as features of pollutant data, modeling complexity, differences between pollutants, and the requirements for training data, these methods only predict a single type of pollutant, such as NOₓ or SO₂. They are unable to perform collaborative prediction for other pollutants like HCl and PM that also exist in the flue gas, resulting in an overly singular prediction target.

Additionally, the effectiveness of the flue gas purification system in controlling and absorbing pollutants directly influences the environmental operating costs of the incinerator and whether the final pollutant emissions comply with standards. Under traditional control strategies, operators primarily rely on CEMS pollutant concentration monitoring data to manually adjust the operation of the flue gas purification equipment and the dosage of environmental protection materials. This experience-based control method is subjective and may introduce delays, which in turn causes significant fluctuations in operating conditions and leads to inaccuracies in reagent control. The Chinese patent application “Machine learning-based flue gas control method, device, equipment, and storage medium” (CN115392437A) discloses a method for controlling flue gas NOₓ using machine learning technology, which can more accurately control ammonia water output. However, this method only targets NOₓ and only considers the cost indicator of ammonia dosage while ignoring environmental protection indicators.

Therefore, it is necessary to provide a method and a system for collaborative prediction and intelligent control of multiple pollutants in waste incineration flue gas. The method and system can construct a collaborative prediction model for the four types of flue gas pollutants, HCl, SO₂, NOₓ, and PM, based on CEMS pollutant concentration monitoring data and incinerator operating condition data. Furthermore, based on the collaborative predicted pollutant concentration results from the model and comprehensive consideration of both cost and environmental protection indicators, this system can achieve the intelligent control of the four types of flue gas pollutants, thereby improving the intelligent operation level of waste incinerators.

### SUMMARY

One or more embodiments of the present disclosure provide a method and a system for collaborative prediction and intelligent control of multiple pollutants in waste incineration flue gas. The method includes:
S1, collecting all historical data of operating parameters of a waste incinerator and emission concentrations of flue gas pollutants at a set time interval within a same time period as collection samples to obtain incinerator operating parameter data and emission concentration data of the flue gas pollutants;
wherein the incinerator operating parameter data is obtained from a storage database of a distributed control system (DCS) of the waste incinerator, the flue gas pollutants include four types of flue gas pollutants: hydrogen chloride (HCl), sulfur dioxide (SO₂), nitrogen oxides (NOₓ), and particulate matter (PM), and the emission concentration data of each type of the flue gas pollutants is obtained from a storage database of a continuous emission monitoring system (CEMS);
S2, for the operating parameters of the waste incinerator and the emission concentrations of the flue gas pollutants in the collection samples obtained in the step S1, calculating a Pearson correlation coefficient between the incinerator operating parameter data and the emission concentration data of each type of the flue gas pollutants; screening, based on the Pearson correlation coefficient between the incinerator operating parameter data and the emission concentration data of any one of the four types of flue gas pollutants, all the operating parameters of the waste incinerator in the collection samples, and retaining a screening result as input features for collaborative prediction training, wherein the emission concentration data of the four types of flue gas pollutants in the collection samples collected at a same time corresponding to the incinerator operating parameter data are used as data labels corresponding to the input features;
S3, performing mean down-sampling with a larger time span on data screened in the step S2; then selecting a part of the incinerator operating parameter data from the collection samples, performing time-series processing thereon to obtain processed data, and using the processed data as input data for training;
constructing a multi-pollutant collaborative prediction model based on a long short-term memory (LSTM) layer structure, inputting incinerator operating parameter data of a set time period to train the multi-pollutant collaborative prediction model, and using a collaborative prediction result corresponding to concentrations of the four types of flue gas pollutants after the set time period as an output of the multi-pollutant collaborative prediction model;
S4, absorbing and treating the four types of flue gas pollutants by a flue gas purification system using a corresponding absorbent respectively; aiming at controlling a dosage of each absorbent corresponding to the four types of flue gas pollutants to construct a multi-objective optimization function F(x), wherein the multi-objective optimization function F(x) is generated based on two types of objective functions: a cost index function considering an absorbent dosage and an environmental protection index function considering pollutant emission amounts, a final optimization objective is to minimize a value of the multi-objective optimization function F(x), and input variables of the cost index function and the environmental protection index function both use a collaborative predicted concentration of flue gas multi-pollutants output by the multi-pollutant collaborative prediction model;
S5, setting a constraint condition for the multi-objective optimization function F(x) according to an actual dosage range of the each absorbent in engineering application and a limit standard of an emission concentration of each pollutant, using a multi-objective optimization algorithm to solve the multi-objective optimization function F(x), and calculating optimal dosage data of the each absorbent corresponding to the four types of flue gas pollutants, respectively, as a calculation result;
S6, inputting the calculation result of the step S5 into the DCS of the waste incinerator, converting the optimal dosage data of the each absorbent corresponding to the four types of flue gas pollutants into an actual analog control signal, and then transmitting the actual analog control signal to a dispensing valve of the each absorbent in the flue gas purification system, wherein by controlling an opening degree of the dispensing valve of the each absorbent, feedback regulation of the dosage of the each absorbent is achieved, ensuring that the flue gas pollutants meet environmental emission standards while reducing the absorbent dosage, thereby achieving a cost-economic objective of the flue gas purification system.

Some embodiments of the present disclosure include, but are not limited to, at least the following beneficial effects.

1. Using a deep learning algorithm, specifically based on an LSTM model, enables accurate collaborative prediction of multiple pollutants in waste incineration flue gas, effectively overcoming the latency issues associated with traditional flue gas pollutant emission monitoring equipment. 2. The collaborative prediction targets covers diverse target types, including HCl, SO₂, NOₓ, and PM, allowing simultaneous prediction of all four pollutant types without the need to train separate prediction models for each pollutant. 3. By coupling the multi-pollutant collaborative prediction model with a multi-objective optimization algorithm, the optimized dosage of absorbents for various pollutants can be quickly determined, enabling intelligent and interconnected feedback control of multiple pollutants. 4. While ensuring that emissions of all types of pollutants in the incinerator flue gas comply with standards, the system minimizes the pollutant control costs of the flue gas purification system to the greatest extent, thereby enhancing the economic efficiency of the incinerator.

### BRIEF DESCRIPTION OF THE DRAWINGS

The present disclosure will be further illustrated by way of exemplary embodiments, which will be described in detail with reference to the accompanying drawings. It will be obvious that the accompanying drawings in the following description illustrate only some of the embodiments of the present disclosure, and for the person of ordinary skill in the art, other accompanying drawings can be obtained according to these drawings under the premise of not exerting creative labor.

FIG. 1 is a flowchart illustrating an exemplary process for collaborative prediction and intelligent control of multiple pollutants in waste incineration flue gas according to some embodiments of the present disclosure;

FIG. 2 is a schematic diagram illustrating a data structure for time-series processing of collection data according to some embodiments of the present disclosure;

FIG. 3 is a flowchart illustrating an exemplary process for intelligent control of multiple pollutants in waste incineration flue gas according to some embodiments of the present disclosure;

FIG. 4 is a schematic diagram illustrating a system for collaborative prediction and intelligent control of multiple pollutants in waste incineration flue gas according to some embodiments of the present disclosure;

FIG. 5 is a schematic diagram illustrating a heat matrix of Pearson correlation coefficients between input features of 32 operating parameters of a waste incinerator and prediction targets of emission concentrations of four types of flue gas pollutants according to some embodiments of the present disclosure;

FIG. 6 is a schematic diagram illustrating a comparative line chart of predicted values of emission concentrations of four types of flue gas pollutants output by a collaborative prediction model and original values according to some embodiments of the present disclosure.

### DETAILED DESCRIPTION

The technical solutions in the embodiments of the present disclosure will be clearly and completely described below in conjunction with the accompanying drawings in the embodiments of the present disclosure.

Obviously, the described embodiments are only a part of the embodiments of the present disclosure, rather than all the embodiments. Based on the embodiments in the present disclosure, all other embodiments obtained by those of ordinary skill in the art without making creative efforts shall fall within the protection scope of the present disclosure.

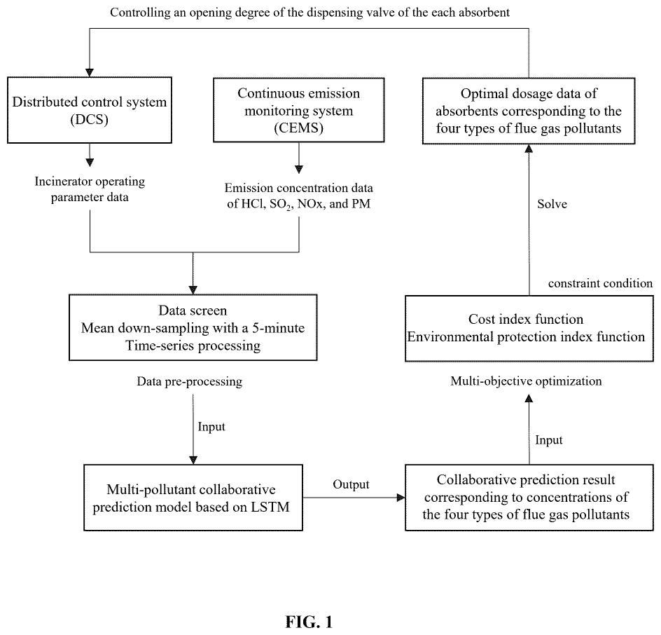

FIG. 1 is a flowchart illustrating an exemplary process for collaborative prediction and intelligent control of multiple pollutants in waste incineration flue gas according to some embodiments of the present disclosure

A method for collaborative prediction and intelligent control of multiple pollutants in waste incineration flue gas, provided according to some embodiments of the present disclosure, may be executed by a processor (e.g., a processor of a DCS and a processor of CEMS). For example, the processor may be a central processing unit (CPU), a graphics processing unit (GPU), an application-specific integrated circuit (ASIC), or other hardware devices with computational capabilities. The processor may also include caches, registers, and other computational resources to increase processing efficiency. The processor can work in concert with other hardware components (e.g., memory, input/output interfaces) to accomplish data reading, processing, and output. The processor may perform a variety of computational tasks, including, but not limited to, data collecting, feature extraction, model training, control of dispensing valves, or the like. As shown in FIG. 1, the method may include the following steps.

Step S1, collecting all historical data of operating parameters of a waste incinerator and emission concentrations of flue gas pollutants at a set time interval within a same time period as collection samples to obtain incinerator operating parameter data and emission concentration data of the flue gas pollutants.

The incinerator operating parameter data is obtained from a storage database of a distributed control system (DCS) of the waste incinerator, the flue gas pollutants include four types of flue gas pollutants: hydrogen chloride (HCl), sulfur dioxide (SO₂), nitrogen oxides (NOₓ), and particulate matter (PM), and the emission concentration data of each type of the flue gas pollutants is obtained from a storage database of a continuous emission monitoring system (CEMS).

In some embodiments, within a same time period, the processor may collect, at the set time interval (e.g. every 1 second), the historical data of the incinerator operating parameter data from the storage database of the DCS of the waste incinerator and the emission concentration data of the four types of flue gas pollutants HCl, SO₂, NOₓ, and PM monitored and obtained by the CEMS.

The DCS of the waste incinerator is an integrated automation system for monitoring and controlling the operation of the incinerator. In some embodiments, the DCS of the waste incinerator employs a distributed architecture to connect control units, sensors, actuators, and human-machine interface (HMI) devices, enabling real-time monitoring, data acquisition, automatic control, and remote operation of the incinerator. The operating parameters of the incinerator stored in the DCS include furnace temperature, flue gas temperature, furnace pressure, oxygen content, steam flow rate, or the like. The CEMS of the waste incinerator includes monitoring components, which may be disposed of at the end of the flue of the waste incinerator.

In some embodiments, the monitoring components include a gaseous pollutant monitoring module, a particulate matter monitoring module, a flue gas parameter monitoring module, a data acquisition and processing module, a data transmission module, or the like. The monitoring components are configured to continuously monitor and record, in real-time, the composition and concentration of various pollutants (e.g., HCl, SO₂, NOₓ, PM, and CO) in flue gas generated from waste incineration. Therefore, utilizing both the DCS and the CEMS facilitates convenient access to the incinerator operating parameter data and concentration data of the flue gas pollutants (i.e., emission concentration data of the flue gas pollutants).

In practical engineering application scenarios, data collected by the DCS and CEMS of the waste incinerator may contain missing values and outliers, which may adversely affect the performance of subsequent predictions. In some embodiments, a statistical algorithm based on the 3-principle and a forward-filling manner may be used to process the missing values and outliers in the collected operating parameter data. The missing values and outliers (e.g., data points beyond three standard deviations) are replaced by the next valid normal value. For the emission concentration data of the four types of pollutants, preset limit standards (e.g., nationally mandated pollutant concentration limits for flue gas emissions from domestic waste incinerators) are used as thresholds. Any emission concentration data exceeding a specified limit of the preset limit standards is replaced with the next available value that falls within the specified limit.

Step S2, for the operating parameters of the waste incinerator and the emission concentrations of the flue gas pollutants in the collection samples obtained in the step S1, calculating a Pearson correlation coefficient between the incinerator operating parameter data and the emission concentration data of each type of the flue gas pollutants; screening, based on the Pearson correlation coefficient between the incinerator operating parameter data and the emission concentration data of any one of the four types of flue gas pollutants, all the operating parameters of the waste incinerator in the collection samples, and retaining a screening result as input features for collaborative prediction training. Emission concentration data of the four types of flue gas pollutants in the collection samples collected at a same time corresponding to the incinerator operating parameter data are used as data labels corresponding to the input features.

The collection samples may be determined based on the collected historical data (e.g., the historical incinerator operating parameter data and the historical emission concentration data of flue gas pollutants). In some embodiments, the incinerator operating parameter data and the emission concentration data of the flue gas pollutants used for determining the Pearson correlation coefficient are historical data collected at the same timestamp.

In some embodiments, in the step S2, the processor may select waste incinerator operating parameters of which the value of the Pearson correlation coefficient with the emission concentration data of any one of the flue gas pollutants is greater than 0.3. These selected operating parameters are then used as input features for collaborative prediction training, while the remaining operating parameters are discarded.

For example, for each of the four flue gas pollutants, a Pearson correlation coefficient may be determined between the incinerator operating parameter data and the emission concentration data of the flue gas pollutant. All operating parameters of which the absolute value of the Pearson correlation coefficient is greater than 0.3 are selected as input features for collaborative prediction. The emission concentrations of the four types of flue gas pollutants are the final collaborative prediction targets.

Since a plurality of sample incinerator operating parameters are collected in Step S1, and not all operating parameters contribute positively to the collaborative prediction of emissions of multiple pollutants in the waste incineration flue gas, the calculation of the Pearson correlation coefficient is utilized to assist in feature screening.

The Pearson correlation coefficient (r) is used to measure a strength and a direction of the linear relationship between two variables, with a value range between [−1, 1]. In some embodiments, the Pearson correlation coefficient is represented by the following formula:

$$r = \frac{n \sum {x}_{i} {y}_{i} - \sum {x}_{i} \sum {y}_{i}}{\sqrt{n \sum {x}_{i}^{2} - {( \sum {x}_{i} )}^{2}} \sqrt{n \sum {y}_{i}^{2} - {( \sum {y}_{i} )}^{2}}} ,$$

where r denotes the Pearson correlation coefficient between variables x and y, n denotes a count of observations, xᵢ denotes the i-th observed value of x, and yᵢ denotes the i-th observed value of y.

In some embodiments, the Pearson correlation coefficient is interpreted as follows: |r|<0.3 indicates no or very weak correlation, 0.3≤|r|<0.5 indicates weak correlation, 0.5≤|r|<0.7 indicates moderate correlation, 0.7≤|r|<0.9 indicates strong correlation, and |r|≥0.9 indicates very strong correlation. Therefore, to enhance the performance of subsequent collaborative prediction of multiple pollutants in waste incineration flue gas while reducing data dimensionality and model complexity, the operating parameters of the waste incinerator with an absolute value of the Pearson correlation coefficient with the emission concentration data of any one of the four types of the flue gas pollutants greater than 0.3 are selected as the input features of the multi-pollutant collaborative prediction model, and the rest of the operating parameters of the waste incinerator are discarded. For the selected operating parameters, the corresponding emission concentration data of the four types of flue gas pollutants in the collection samples at the same timestamp serve as the data labels for the input features of the collection samples.

Step S3, performing mean down-sampling with a larger time span on data screened in the step S2; then selecting a part of the incinerator operating parameter data from the collection samples, performing time-series processing thereon to obtain processed data, and using the processed data as input data for training, and constructing a multi-pollutant collaborative prediction model based on a long short-term memory (LSTM) layer structure, inputting incinerator operating parameter data of a set time period to train the multi-pollutant collaborative prediction model, and using a collaborative prediction result corresponding to concentrations of the four types of flue gas pollutants after the set time period as an output of the multi-pollutant collaborative prediction model.

The multi-pollutant collaborative prediction model (hereinafter referred to as the collaborative prediction model or the prediction model) refers to a model used for predicting the emission concentrations of the four types of flue gas pollutants. The collaborative prediction model may be constructed based on machine learning algorithms (e.g., RNN, LSTM). More descriptions regarding the multi-pollutant collaborative prediction model may be found in the following description of the present disclosure. The screened data refers to the selected incinerator operating parameter data and the emission concentration data of the four types of flue gas pollutants. The larger time span may be a preset time span or period, which is a longer time period compared to the set time interval in Step S1. In some embodiments, the larger time span may be 5 minutes.

In some embodiments, the set time interval for data collection in the step S1 is 1 second, and mean down-sampling with a 5-minute interval is performed on the data screened in the step S2; for a prediction target of each sample after the mean down-sampling, the incinerator operating parameter data of first 12 samples of the collection samples are used as the input features of the multi-pollutant collaborative prediction model.

In some embodiments, the processor may perform time-series processing on the input data and train the collaborative prediction model. The collaborative prediction model is capable of outputting a collaborative prediction result corresponding to the emission concentrations of the four types of flue gas pollutants after the set time period, based on the incinerator operating parameter data from the set time period. More descriptions regarding the multi-pollutant collaborative prediction model may be found in the following description of the present disclosure.

The time-series processing refers to a process of constructing input data into a format with temporal dependencies. The time-series processing includes, but is not limited to, procedures such as temporal alignment (e.g., timestamp matching) and temporal sliding window sampling.

Taking the set time interval of 1 second in Step S1 as an example, the collected data is high-frequency second-level data. Even over a relatively short period, this may result in a substantial data amount. Therefore, averaging the collected data over the larger time span, for example, using a 5-minute time window, yields samples where each data point represents the average of original data over the corresponding 5-minute period. This approach reduces the temporal resolution of the raw data and decreases the data amount, while preserving the overall trends and main features of the data, thereby avoiding the loss of critical information that might occur if data were simply discarded. Furthermore, the 5-minute mean down-sampling process helps smooth out short-term random fluctuations and noise, facilitating a focus on long-term trends or significant changes in the data.

The generation of pollutants (e.g., flue gas pollutants) is not only influenced by the state of the incinerator at a single moment but also depends on the entire process throughout waste incineration. Therefore, for the prediction model, using time-series data for prediction is more reasonable compared to using input features from a specific moment to predict the pollutant concentration at that same moment. This approach facilitates the ability of the collaborative prediction model to obtain patterns and trends that evolve over time, thereby enhancing the accuracy and stability of predictions.

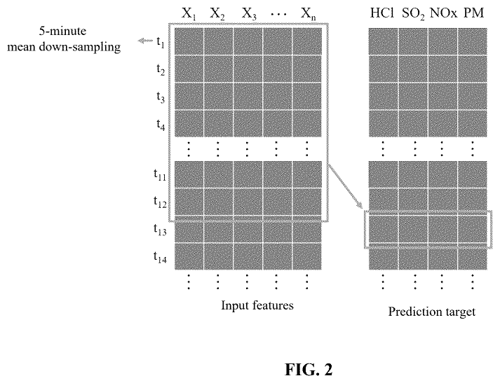

FIG. 2 is a schematic diagram illustrating a data structure for time-series processing of collection data according to some embodiments of the present disclosure.

As shown in FIG. 2, since the collected data has undergone mean down-sampling over a preset time span (e.g., 5 minutes), each data point corresponds to an average value of the original data over a 5-minute period. At this stage, the data at each time point is combined with data from the preceding 11 consecutive time points to form a time-series sequence of length 12, which is then input into the collaborative prediction model to predict the emission concentrations of the four types of flue gas pollutants at the next time point. This process effectively implements the time-series processing of the input data for the collaborative prediction model.

In some embodiments, before formally training the collaborative prediction model, the processor may perform normalization on the input data to scale the numerical range of the input features to a unified scale (e.g., [−1, 1]), thereby mitigating the impact of numerical disparities among different features. Meanwhile, a dataset is divided into a training set, a validation set, and a testing set in a specific ratio according to chronological order.

In some embodiments, in the step S3, the multi-pollutant collaborative prediction model has 2 LSTM layers and 1 Dense layer. A count of neurons in the Dense layer is 4, an input time step is 12, an output prediction step is 1, an optimizer is adaptive moment estimation (Adam), a loss function is mean squared error (MSE), and a maximum count of iterations is set to 100. A count of neurons in each LSTM layer, a type of activation function, and a learning rate are used as hyperparameters of the multi-pollutant collaborative prediction model, and an optimal parameter is determined by using a grid search manner.

The multi-pollutant collaborative prediction model provided in the present disclosure is a Recurrent Neural Network (RNN) model capable of effectively processing time-series data. It is particularly suitable for forecasting sequential data with temporal dependencies. The multi-pollutant collaborative prediction model learns patterns and trends of the incinerator operating parameters over time, providing a reliable basis for accurate collaborative prediction of future multi-pollutant concentrations in the flue gas. The LSTM layer refers to a long short-term memory layer, which primarily utilizes forget gates and memory cells to determine which information should be retained or discarded.

Each LSTM layer contains a plurality of neurons capable of capturing temporal dependencies in the time-series data. The count of neurons in each LSTM layer is determined through hyperparameter optimization. The Dense layer refers to a fully connected layer, which is used to integrate feature outputs from preceding layers to generate a final prediction result.

In some embodiments, the count of neurons in the Dense layer is set to 4, corresponding to the four prediction targets representing the concentrations of the four types of pollutants. Meanwhile, the collaborative prediction model accepts input data from the previous 12 time steps (i.e., a preceding 60 minutes, with one data point per 5 minutes), which forms a time-series sequence. For each input sequence, the model predicts the value for a single subsequent time step (i.e., a next 5-minute).

The hyperparameters of the collaborative prediction model (e.g., the count of neurons in each LSTM layer, the type of activation function, and the learning rate) significantly influence the predictive performance of the collaborative prediction model. An optimal hyperparameter combination may be determined via a grid search manner. In some embodiments, the processor may evaluate a plurality of hyperparameter combinations via the grid search manner and select one that yields the best performance of the collaborative prediction model as the optimal hyperparameter combination.

In some embodiments, the processor may construct a search space based on candidate values for the count of neurons in each LSTM layer, candidate activation functions, and candidate learning rates. For example, a first candidate neuron count corresponding to a first LSTM layer may include 32, 64, and 128; a second candidate neuron count corresponding to a second LSTM layer may include 32, 64, and 128; the candidate activation functions may include ReLU and Tanh; and the candidate learning rates may include 0.01, 0.001, and 0.005. The processor may generate a plurality of hyperparameter combinations by combining the first candidate neuron count, the second candidate neuron count, the candidate activation function, and the candidate learning rate. An exemplary combination is (64, 64, ReLU, 0.005), indicating 64 neurons in the first LSTM layer, 64 neurons in the second LSTM layer, ReLU as the activation function, and a learning rate of 0.005. To more accurately evaluate the model performance corresponding to each hyperparameter combination, the processor may use a cross-validation manner for evaluation. In some embodiments, the processor divides a training set data into K equally sized and mutually exclusive subsets (e.g., K=5 or K=10). Each time, K−1 subsets are used as training sets, and the remaining subset is used as a validation set. This training and validation process is repeated K times, ensuring that each subset serves as the validation set once. Finally, an average evaluation performance metric of each hyperparameter combination across the K validations is calculated to eliminate the randomness caused by data partitioning, thereby enabling a more reliable assessment of the predictive accuracy and generalization capability of the collaborative prediction model.

In some embodiments, the performance of the collaborative prediction model may be evaluated using two metrics: Mean Squared Error (MSE) and Mean Absolute Error (MAE).

The MAE is used to evaluate the deviation between the predicted results corresponding to input data and true values (data labels). The MSE amplifies errors through squaring to assess significant deviations of the collaborative prediction model. Evaluating model performance using the MAE and the MSE enhances the accuracy of the trained collaborative prediction model.

In some embodiments, a deep learning model is utilized to achieve collaborative prediction of the four pollutants (HCl, SO₂, NOₓ, and PM) in waste incineration flue gas. This approach eliminates the need for continuous reliance on the CEMS, which suffers from measurement delays and high maintenance costs, for monitoring flue gas pollutant concentrations. Instead, by inputting continuously recorded operating condition data stored in the incinerator's DCS system into the model, collaborative predictions for the concentrations of the four types of pollutants can be obtained simultaneously. The collaborative prediction model employs an LSTM model, which is specifically designed to process and predict time-series data with long-term dependencies. Furthermore, since the generation of pollutants is influenced not only by a state of the incinerator at a specific moment but also depends on the entire waste incineration process, applying time-series processing to the input data of the LSTM model enables more accurate collaborative prediction performance.

Step S4, absorbing and treating the four types of flue gas pollutants by a flue gas purification system using a corresponding absorbent respectively; aiming at controlling a dosage of each absorbent corresponding to the four types of flue gas pollutants to construct a multi-objective optimization function F(x), wherein the multi-objective optimization function F(x) is generated based on two types of objective functions: a cost index function considering an absorbent dosage and an environmental protection index function considering pollutant emission amounts, a final optimization objective is to minimize a value of the multi-objective optimization function F(x), and input variables of the cost index function and the environmental protection index function both use a collaborative predicted concentration of flue gas multi-pollutants output by the multi-pollutant collaborative prediction model.

The absorbent dosage is also referred to as a dosage of the absorbent. In some embodiments, with the objective of controlling the dosage of absorbents corresponding to the treatment of the four flue gas pollutants (i.e., HCl, SO₂, NOₓ, and PM) in the flue gas purification system, the processor may construct a multi-objective optimization function F(x) based on a cost index function and an environmental protection index function. In some embodiments, both the cost index function and the environmental protection index function utilize a collaborative predicted concentration of flue gas multi-pollutants as an input variable. The collaborative predicted concentration refers to collaborative prediction results of the concentrations of the four types of flue gas pollutants output in Step S3. The ultimate optimization goal is to minimize the value of the optimization function F(x).

In some embodiments, in the step S4, an expression of the multi-objective optimization function F(x) is as follows:

$$min F ( x ) = [ {f}_{1} ( x ) , {f}_{2} ( x ) , {f}_{3} ( x ) , {f}_{4} ( x ) , {g}_{1} ( x ) , {g}_{2} ( x ) , {g}_{3} ( x ) , {g}_{4} ( x ) ] ,$$

where f(x) is the cost index function indicating the absorbent dosage, g(x) is the environmental protection index function, and subscripts 1, 2, 3, and 4 denote the four types of flue gas pollutants HCl, SO₂, NOₓ, and PM, respectively.

The absorbent refers to a substance used to absorb pollutants (e.g., the four types of flue gas pollutants), which may be various adsorbents.

In some embodiments, in the step S4, absorbents corresponding to absorbing and treating the four types of flue gas pollutants HCl, SO₂, NOₓ, and PM are hydrated lime, sodium hydroxide, ammonia water, and activated carbon, respectively.

In some embodiments of the present disclosure, by designating the dosages of the four absorbents as optimization objectives of the multi-objective optimization function, the emissions of the four flue gas pollutants from the incinerator can be effectively linked to the adjustment of the corresponding absorbent dosages. This enables precise adjustment of the dispensing amount of each absorbent, thereby reducing the emission levels of the respective pollutants and ensuring that the discharged flue gas pollutants consistently remain within compliant standards.

In some embodiments, the cost index function f(x) is represented by the following formula:

$$f ( x ) = ( {C}_{i n} - {C}_{o u t} ) \times V \times \frac{{M}_{A b s}}{{M}_{P}} \times η ,$$

where f(x) indicates the absorbent dosage; Cᵢₙ is an inlet flue gas pollutant concentration of the flue gas purification system; Cₒᵤₜ is the collaborative predicted concentration of the flue gas pollutants; V is a flue gas flow rate; M_{Abs} is a molecular molar mass of a main reaction component of the absorbent; M_{P} is a molecular molar mass of a main component of a certain type of pollutant; and η is an actual pollutant removal efficiency.

In some embodiments, the environmental protection index function g(x) is represented by the following formula:

$$g ( x ) = f ( Q ) ,$$

where g(x) is a pollutant concentration; f is the multi-pollutant collaborative prediction model; Q is an absorbent dosage, which is a controllable variable.

In some embodiments of the present disclosure, the integration of the collaborative prediction model with the multi-objective optimization process enables simultaneous fulfillment of both cost control and environmental protection requirements. Specifically, the collaborative prediction model provides collaborative predicted results of the concentrations of the four types of flue gas pollutants (e.g., the collaborative predicted concentrations of multiple flue gas pollutants), which serve as a basis for subsequent decision-making and control. These collaborative prediction results are directly used as input variables in the multi-objective optimization, feeding into both the cost index function and the environmental protection index function, thereby establishing a linkage between the collaborative prediction model and the multi-objective optimization process. Based on the pollutant concentrations output by the collaborative prediction model, the processor can dynamically adjust the operational strategy of the incinerator, i.e., the dosage of absorbent corresponding to each flue gas pollutant. Through this approach, the optimization model balances cost and environmental objectives to identify an optimal solution. By comprehensively considering both cost and environmental indicators in the multi-pollutant control process, optimal dosage data for the absorbents corresponding to the four types of flue gas pollutants are computed.

Step S5, setting a constraint condition for the multi-objective optimization function F(x) according to an actual dosage range of the each absorbent in engineering application and a limit standard of an emission concentration of each pollutant, using a multi-objective optimization algorithm to solve the multi-objective optimization function F(x), and calculating optimal dosage data of the each absorbent corresponding to the four types of flue gas pollutants, respectively, as a calculation result.

The limit standard of an emission concentration of each pollutant may be the nationally mandated concentration limit standard for the four types of pollutants.

The constraint condition of the multi-objective optimization function F(x) is used to restrict the solutions during the optimization process, ensuring that the final solution is not only optimal in terms of the value of the objective function F(x) but also satisfies various limitations in practical applications. The constraint condition guarantees that the optimization result is feasible in reality and complies with specific operational requirements of the system. A solution that satisfies the constraint condition may be referred to as a feasible solution.

For example, in engineering problems, dosages of absorbents must remain within practically allowable ranges and cannot exceed the equipment capacity or economically acceptable limits. Meanwhile, in multi-objective optimization involving environmental protection, the constraint condition ensures that the emission concentrations of flue gas pollutants do not exceed legally mandated limits, thereby preventing violations of environmental regulations.

In some embodiments, in the step S5, the multi-objective optimization algorithm is a particle swarm optimization algorithm, an algorithm model corresponding to the particle swarm optimization algorithm is constructed by calling a pso function in a pyswarm library, a count of particles is set to 10, and a maximum count of iterations is 10.

The particle swarm optimization (PSO) is a swarm intelligence-based optimization algorithm that simulates the behavior of bird flocks foraging or fish schools swimming to find an optimal path. The PSO explores a search space through a population of individuals referred to as “particles”, each particle representing a potential solution. The particles continuously adjust their positions based on both their own experience and the collective experience of the swarm to seek a global optimal solution.

In some embodiments, the processor may execute the PSO algorithm by randomly generating a population of particles, where the position of each particle represents a possible solution. Each particle is also assigned an initial velocity, which determines its direction and step size of movement within the search space. The position of each particle is then evaluated via an objective function, which determines the quality of the solution, i.e., the “fitness” of the particle. Subsequently, the PSO algorithm performs velocity and position updates to refresh the personal best (or local best) and the global best. The processor may repeat the process of velocity and position updates until a maximum count of iterations is reached or the optimal solution is converged to.

In some embodiments, the velocity of each particle is updated according to the following formula:

$${v}_{i} ( t + 1 ) = w \cdot {v}_{i} ( t ) + {c}_{1} \cdot {r}_{1} \cdot ( {p}_{i}^{b e s t} - {x}_{i} ( t ) ) + {c}_{2} \cdot {r}_{2} \cdot ( {g}^{best} - {x}_{i} ( t ) ) ,$$

where vᵢ(t+1) denotes the velocity of particle i at time t+1, vᵢ(t) denotes the velocity of the particle i at time t, xᵢ(t) denotes the position of the particle i at time t,

$${p}_{i}^{b e s t}$$

denotes the personal best position of the particle i, g^{best} denotes the global best position, w denotes the inertia weight, c₁ and c₂ denote learning factors, which control the ability of the particle to learn from the personal best position and the global best position, respectively, r₁ and r₂ denote random numbers used to introduce stochasticity, which may be set to values within the range [0, 1].

In some embodiments, the position of a particle is updated based on its velocity, which may be represented by the following formula:

$${x}_{i} ( t + 1 ) = {x}_{i} ( t ) + {v}_{i} ( t + 1 ) ,$$

where xᵢ(t+1) denotes the position of particle i at time t+1; xᵢ(t) denotes the position of particle i at time t; vᵢ(t+1) denotes the velocity of particle i at time t+1, i.e., the updated velocity as described above.

The pyswarm is a classical python library specifically designed for implementing the PSO algorithm. The pyswarm provides a user-friendly pso function for performing optimization tasks. The pso function defines the objective function via the func parameter, specifies the lower and upper bounds of the search space via lb and ub parameters, and sets the count of particles and the maximum count of iterations via the swarmsize and maxiter parameters. A breadth with which the PSO algorithm explores the solution space in each iteration may be determined by the count of particles. A larger count of particles can increase the probability of finding the global optimal solution, but increase computational complexity. The maximum count of iterations determines a running duration of the algorithm, and a larger count of iterations allows the particle swarm more opportunities to converge to the global optimal solution.

In some embodiments, after a plurality of iterative computations, the PSO algorithm eventually identifies one or more optimal solutions. The one or more optimal solutions represent dosage configurations of absorbents corresponding to the flue gas pollutants that minimize cost and meet environmental protection requirements under the given constraint condition. The one or more optimal solutions represent the optimal dosage data of the absorbents corresponding to the treatment of the four types of flue gas pollutants.

In some embodiments, for the one or more optimal solutions, the processor may further select one optimal solution as the final optimal dosage data based on cost requirements and environmental protection requirements. For example, a first weight corresponding to the cost index and a second weight corresponding to the environmental protection index may be set. The first weight and the second weight may be determined according to actual needs. Merely by way of example, in a cost-prioritized scenario (i.e., where minimizing cost is the primary consideration), the processor may select, from the one or more optimal solutions, the absorbent dosage corresponding to the flue gas pollutant with the lowest cost as the final optimal dosage data.

Step S6, inputting the calculation result of the step S5 into the DCS of the waste incinerator, converting the optimal dosage data of the each absorbent corresponding to the four types of flue gas pollutants into an actual analog control signal, and then transmitting the actual analog control signal to a dispensing valve of the each absorbent in the flue gas purification system, wherein by controlling an opening degree of the dispensing valve of the each absorbent, feedback regulation of the dosage of the each absorbent is achieved, ensuring that the flue gas pollutants meet environmental emission standards while reducing the absorbent dosage, thereby achieving a cost-economic objective of the flue gas purification system.

In some embodiments, the DCS of the waste incinerator may convert the optimal dosage data of each absorbent obtained by the multi-objective optimization algorithm into the actual analog control signals. The actual analog control signals may then be transmitted to the dispensing valve of the each absorbent in the flue gas purification system. By controlling the opening degree of each dispensing valve, feedback regulation of the dosage of the four types of flue gas pollutants can be achieved.

In some embodiments, in the step S6, the actual analog control signal is a current signal of 4˜20 mA. When the dosage of the absorbent to be controlled is 0%, the dispensing valve is fully closed, and a corresponding current signal is 4 mA. When the dosage of the absorbent to be controlled is 100%, the dispensing valve is fully open, and a corresponding current signal is 20 mA. During transmission of the actual analog control signal, Modbus is used as a data communication protocol.

In some embodiments, the opening degree of the dispensing valves may be determined based on a preset relationship table. This preset relationship table includes a relationship between the absorbent dosages, the opening degrees of the dispensing valves, and the corresponding analog control signal (e.g., current signals). It should be noted that the analog control signal may also be other types of signals (e.g., a voltage signal).

In some embodiments of the present disclosure, after the optimal dosages of absorbents corresponding to the four types of flue gas pollutants are determined using the multi-objective optimization algorithm, the optimal dosages of absorbents may be converted into control signals by the DCS of the incinerator and sent to the dispensing valves for the respective absorbents in the flue gas purification system. By controlling the opening degree of the dispensing valves, precise feedback regulation of the dosages of the four absorbents can be achieved. Under the feedback-adjusted absorbent dosage levels, not only can the emissions of all four pollutants in the flue gas be guaranteed to comply with standards, but also the operating costs of the incineration flue gas purification system can be minimized to the greatest extent, further enhancing the intelligent operation level of the incinerator.

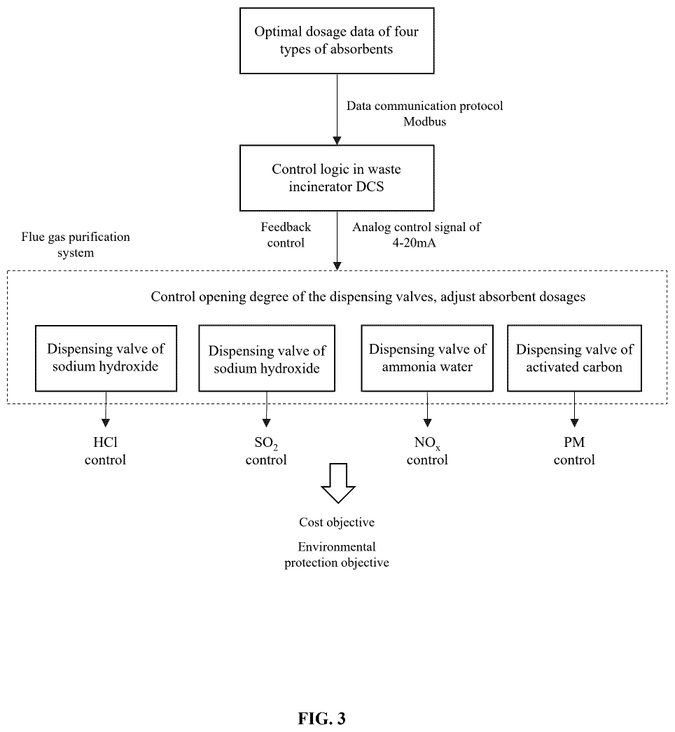

FIG. 3 is a flowchart illustrating an exemplary process for intelligent control of multiple pollutants in waste incineration flue gas according to some embodiments of the present disclosure.

As shown in FIG. 3, a control objective in some embodiments of the present disclosure is to achieve effective control of the emission concentrations of the four types of pollutants in the incinerator flue gas based on optimal results of the optimal dosage data of each absorbent obtained by the multi-objective optimization algorithm, ensuring compliance with environmental emission standards while optimizing absorbent usage and reducing costs. A feedback control strategy is used to convert the optimal results into actual analog control signals, thereby adjusting the operating parameters of the system (e.g., the flue gas purification system) and enabling real-time regulation of the absorbent dosage.

In some embodiments, the multi-objective optimal results (i.e., the optimal dosages of absorbents of the four types of pollutants) may be integrated with the controller of an actual flue gas purification system, which is the DCS of the waste incinerator. In some embodiments, it is also necessary to ensure that the computer or server running the LSTM model (i.e., the multi-pollutant collaborative prediction model) and the optimization algorithm (e.g., the PSO algorithm) may communicate with the controller, which involves the use of the industrial communication protocol Modbus. The flue gas purification system includes electronic dispensing valves used to adjust the dosage of absorbent corresponding to each of the flue gas pollutants. The electronic dispensing valves require a control signal (e.g., an analog signal), such as a 4-20 mA current signal or a 0-10 V voltage signal. By pre-programming corresponding control logic in the DCS, the system converts the received absorbent dosage data determined by the optimization algorithm into corresponding analog output signals. These analog control signals are then transmitted to the electronic dispensing valves to dynamically adjust the opening degrees of the electronic dispensing valves, thereby achieving feedback control of the pollutant absorbent dosage.

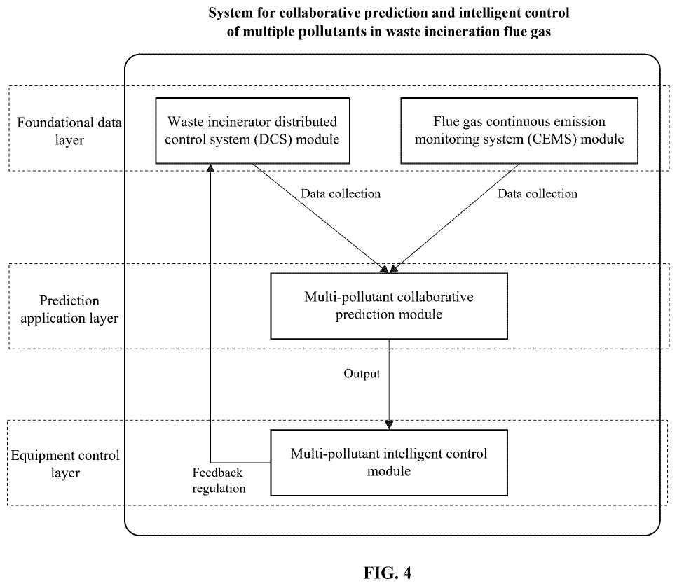

FIG. 4 is a schematic diagram illustrating a system for collaborative prediction and intelligent control of multiple pollutants in waste incineration flue gas according to some embodiments of the present disclosure.

As shown in FIG. 4, a system for collaborative prediction and intelligent control of multiple pollutants in waste incineration flue gas is provided according to some embodiments of the present disclosure. The system includes:
a waste incinerator distributed control system (DCS) module configured to collect and store real-time operating parameter data of a waste incinerator;
a flue gas continuous emission monitoring system (CEMS) module located at an end position of a flue of the waste incinerator and configured to collect and store real-time emission concentration data of four types of pollutants, HCl, SO₂, NOₓ, and PM, in a waste incineration flue gas;
a multi-pollutant collaborative prediction module configured to execute operations, data processing, model training, outputting a collaborative predicted concentration of the flue gas multi-pollutants using the multi-pollutant collaborative prediction model, and calculating an optimal absorbent dosage;
a multi-pollutant intelligent control module configured to issue control signals for an opening degree of a dispensing valve of each absorbent in the flue gas purification system, and to reduce a flue gas purification cost of the flue gas purification system.

The waste incinerator DCS module and the flue gas CEMS module belong to a foundational data layer of the system, responsible for monitoring and collecting operating parameter data of the incinerator and pollutant emission concentration data. The multi-pollutant collaborative prediction module belongs to a computation and prediction application layer implemented in the form of software programs, and may be configured to achieve data processing, model training, outputting a collaborative predicted concentration of the flue gas multi-pollutants using the multi-pollutant collaborative prediction model, and calculating an optimal absorbent dosage. The multi-pollutant intelligent control module belongs to the equipment control layer of the system. It is responsible for receiving the collaborative prediction results from the computation and prediction application layer, coupling with the multi-objective optimization algorithm, and achieving feedback control of the incinerator flue gas purification system by adjusting the dosage of the four types of pollutant absorbents.

The system is collectively constructed based on the four modules. The four modules work in close coordination to enable real-time monitoring, prediction, and control of flue gas during the waste incineration process, achieving the goals of optimizing pollutant emission treatment and reducing operational costs.

In some embodiments, the processor may collect 36 days of operating parameter data (i.e., incinerator operating parameter data) stored in the DCS and emission concentration data of the four pollutants HCl, SO₂, NOₓ, and PM monitored by the CEMS from a waste incineration plant in Zhejiang Province. A set time interval of sampling is 1 second, resulting in a total of 3,116,417 collected samples. The operating parameters include 221 items such as main steam pressure, main steam temperature, incinerator furnace temperature, and induced draft fan outlet pressure.

The processor may use the 3σ principle and a forward-filling manner to process missing values and outliers in the collected data. The identification of outliers in emission concentration data of the flue gas pollutants is based on limit standards for pollutant concentrations in flue gas emissions from domestic waste incinerators. In this embodiment, the emission limit standards for the four types of pollutants, HCl, SO₂, NOₓ, and PM, are 0-10 mg/Nm³, 0-50 mg/Nm³, 0-90 mg/Nm³, and 0-10 mg/Nm³, respectively.

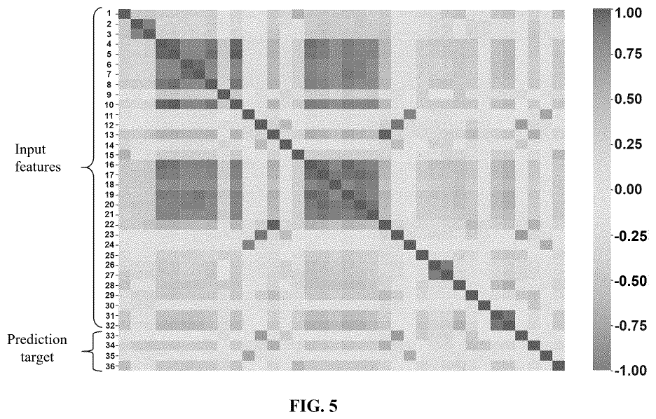

After completing the processing of missing values and outliers, a Pearson correlation coefficient is utilized to screen the operating parameters that exhibit strong correlations with the concentration data of the four types of flue gas pollutants from a total of 221 incinerator operating parameters. In this embodiment, through computational statistics, 32 incinerator operating parameters are ultimately selected as input features for collaborative prediction. The Pearson correlation coefficients between the 32 input features and the prediction targets of emission concentrations of four types of flue gas pollutants may be represented by a heat matrix diagram shown in FIG. 5.

FIG. 5 is a schematic diagram illustrating a heat matrix of Pearson correlation coefficients between input features of 32 operating parameters of a waste incinerator and prediction targets of emission concentrations of four types of flue gas pollutants according to some embodiments of the present disclosure.

As shown in FIG. 5, to reduce the complexity of the multi-pollutant collaborative prediction model and the dimensionality of the data, while also shortening subsequent model training time, the processor may apply a 5-minute mean down-sampling to process the input data. This involves sampling original data at 5-minute intervals instead of the original 1-second sampling rate. Furthermore, for a prediction target of each collected sample, input feature data from the 60 minutes preceding the corresponding time point (corresponding to 12 down-sampled data points) is used for prediction. The processor then performs time-series processing on the input data of the multi-pollutant collaborative prediction model. After the down-sampling and time-series processing, the dimensionality of the sample data for each hour is reduced from 3600×32 to 12×32, significantly lowering the data dimensionality. In this embodiment, after the above processing is completed, a total of 13,958 samples remain. Subsequently, row-wise normalization is applied to the sample data. In this embodiment, the processor may use a z-score normalization algorithm, transforming the original sample data into a distribution with a mean of 0 and a standard deviation of 1.

In this embodiment, the processor constructs the multi-pollutant collaborative prediction model based on Python (v3.9.7) and TensorFlow (v2.8.0). The prediction model has 2 LSTM layers and 1 Dense layer. A count of neurons in the Dense layer is 4, an input time step is 12, and an output prediction step is 1. An optimizer is Adam, MSE is used as a loss function, and a maximum count of iterations is set to 100. The hyperparameters to be determined for the prediction model include a count of neurons in each LSTM layer, a type of activation function, and a learning rate. In this embodiment, values of the hyperparameters determined by a grid search manner are shown in Table 1.

TABLE 1
Hyperparameters of the multi-pollutant
collaborative prediction model

| Hyperparameter | value |
|---|---|
| Count of neurons in LSTM 1 | 64 |
| Count of neurons in LSTM 2 | 64 |
| Activation function | ReLU |
| Learning rate | 0.005 |

In this embodiment, before training, a dataset is divided into a training set, a validation set, and a testing set in a ratio of 7:2:1 according to chronological order.

After training, MSE and MAE may be used to evaluate the performance of the collaborative prediction model. In this embodiment, the average MAE and MSE of the prediction results for the emission concentrations of the four types of flue gas pollutants predicted by the collaborative prediction model based on the validation set and testing set are shown in Table 2.

TABLE 2
MAE and MSE Results of the Collaborative Prediction Model

| | |
|---|---|
| Validation set | Testing set |

| MAE | MSE | MAE | MSE |
|---|---|---|---|
| 0.68 | 0.87 | 0.73 | 1.10 |

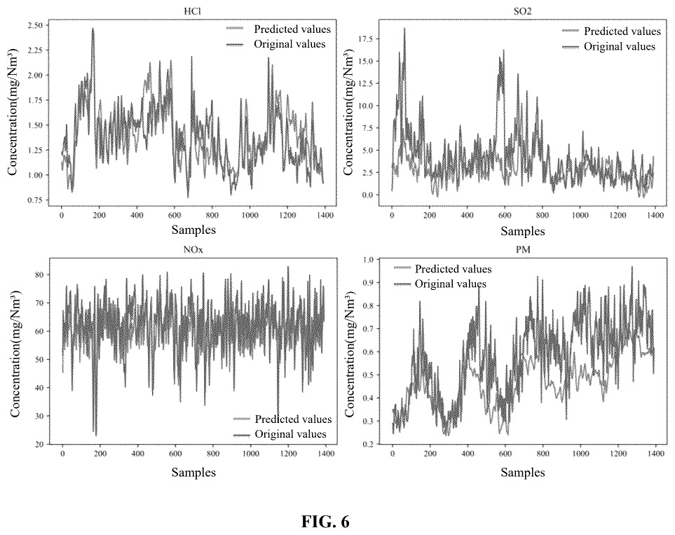

In this embodiment, to more clearly visualize the collaborative prediction performance of the collaborative prediction model for the four types of flue gas pollutants, a comparative line chart of the predicted values versus original values for the concentrations of the four types of flue gas pollutants is shown in FIG. 6.

FIG. 6 is a schematic diagram illustrating a comparative line chart of predicted values of emission concentrations of four types of flue gas pollutant output by a multi-pollutant collaborative prediction model and original values according to some embodiments of the present disclosure.

In some embodiments, to make the variation trends of the pollutants more intuitive, the processor applies a moving average to the data (i.e., the predicted values and the original values), with a window size set to 6 and a step size set to 1. As shown in FIG. 6, the multi-pollutant collaborative prediction model demonstrates effective collaborative prediction for the four types of flue gas pollutants, capable of promptly predicting fluctuations in their emission concentrations. Therefore, the accuracy of the collaborative prediction results of the prediction model can provide a reliable foundation for subsequent intelligent pollutant control, such as the dosing control of absorbents.

Due to the fact that the control of flue gas pollutants involves a plurality of constraints (e.g., cost budgets, production scheduling, and environmental protection requirements), it is highly suitable for solving using a multi-objective optimization algorithm. In some embodiments, the control of flue gas pollutants considers two objectives: one is the cost of absorbent dosage required to treat the four types of pollutants, and the other is ensuring that pollutant emissions comply with regulations from an environmental protection perspective. In this embodiment, a cost index function f(x) and an environmental protection index function g(x) are constructed for each of the four types of flue gas pollutants. Since controlling NOₓ in waste incineration flue gas is more complex and cumbersome compared to HCl, SO₂, and PM, and the control processes for the four types of pollutants are relatively similar, this embodiment will use the control of NOₓ pollutant as an example to describe the subsequent steps.

In the flue gas purification system of the waste incinerator, the absorbent corresponding to the treatment of NOₓ pollutant is ammonia water (NH₃·H₂O). Therefore, the control of NOₓ in the incinerator is linked to the control of an NH₃·H₂O dosage. Additionally, for simplification of calculations, NOₓ is considered as NO. The constructed cost index function f₃(x) is represented by the following formula:

$${f}_{3} ( x ) = ( {C}_{{NO}_{x \_} i n} - {C}_{{NO}_{x \_} o u t} ) \times V \times \frac{{M}_{{NH}_{3}}}{{M}_{NO}} \times η ,$$

where f₃(x) denotes a cost of ammonia injection for treating NOₓ in the waste incineration flue gas, C_{NO}_{ₓ}_{_in} denotes the NOₓ concentration received by the flue gas purification system, C_{NO}_{ₓ}_{_out} denotes the predicted concentration of the NOₓ, V denotes a flue gas flow rate, M_{NH}_{₃} and M_{NO} denote molecular molar masses of NH₃ and NO, respectively, η denotes an actual removal efficiency of the NOₓ, which is set to 0.8 in this embodiment.

The environmental protection index function g₃(x) is represented by the following formula:

$${g}_{3} ( x ) = f ( Q ) ,$$

where g₃(x) denotes a pollutant concentration of the NOₓ in the waste incineration flue gas, f denotes the multi-pollutant collaborative prediction model, and Q denotes the NH₃·H₂O dosage, which is a controllable variable.

As evidenced by C_{NO}_{ₓ}_{_out} in the cost index function for NOₓ control and f in the environmental protection index function, both functions utilize the predicted NOₓ concentration output from the multi-pollutant collaborative prediction model as an input, thereby establishing a connection between the prediction model and the multi-objective optimization. Based on the two objective functions mentioned above, the final objective function is represented by the following formula:

$$min F ( x ) = {k}_{1} * {f}_{3} ( x ) + {k}_{2} * {g}_{3} ( x ) ,$$

The constraint condition (i.e., constraints) is represented by the following formula:

$$\{ \begin{matrix}0 \leq Q \leq 150 L / h \\ 0 \leq {g}_{3} ( x ) \leq 90 mg / {m}^{3}\end{matrix} ,$$

where k₁ and k₂ denote weight coefficients of the cost function and the environmental protection function, respectively. The weight coefficients are used to adjust the weight distribution between the two objective functions, and are both set to 1 in this embodiment. Additionally, to prevent excessive adjustments of the control variable, the adjustment range of the controllable variable Q is limited to within 5 L/h per adjustment.

The processor utilizes the PSO algorithm implemented in Python to construct an optimization model (an algorithm model corresponding to the PSO algorithm) and then solves the multi-objective function based on the optimization model. Specifically, during the optimization model construction, the count of particles is set to 10, and a maximum count of iterations is set to 10. Through iterative computation, the optimal dosage data of the NH₃·H₂O absorbent satisfying the constraint condition is determined. The optimal dosage data of the NH₃·H₂O absorbent is then converted into an analog control signal and transmitted to the electronic dispensing valve for NH₃·H₂O dosing within the flue gas purification system of the waste incinerator. By adjusting the opening degree of the electronic dispensing valve, an actual NH₃·H₂O dosing flow rate is controlled, thereby achieving effective and low-cost control of NOₓ pollutants in the flue gas. More descriptions regarding the algorithm model corresponding to the PSO algorithm may be found in FIG. 1 and related descriptions thereof.

Correspondingly, a system for collaborative prediction and intelligent control of multiple pollutants in waste incineration flue gas is provided according to this embodiment. The system includes a waste incinerator DCS module, a flue gas CEMS module, a multi-pollutant collaborative prediction module, and a multi-pollutant intelligent control module. The four modules cooperate with each other to collectively accomplish an objective of collaborative prediction and intelligent control of multiple pollutants in waste incineration flue gas. In this embodiment, Python is adopted as a primary programming language for the system development. The program of the system is compiled in a MSVC2019 32-bit environment, while Qt is used as an application development framework. Additionally, Modbus is used as a data communication protocol, and Visual Studio Code (VS Code) serves as an integrated development environment (IDE) for the programming of the system.

To validate the effectiveness of the system provided in the present disclosure, in this embodiment, the system was deployed and applied to a waste incinerator. Operating data was obtained continuously for 120 hours from an incineration plant (the waste incinerator), and the obtained data was used to conduct an optimized control test on the NH₃·H₂O dosage. The results show that the average NH₃·H₂O spray amount was 11.79 L/h before optimization and the average NH₃·H₂O spraying amount was 10.63 L/h after optimization, representing a reduction of 9.84%. This can effectively reduce the cost of environmental protection materials in the flue gas purification system while ensuring that pollutant emissions meet the standards, achieving a dual benefit.

In summary, the method for collaborative prediction and intelligent control of multiple pollutants in waste incineration flue gas provided in some embodiments of this disclosure, not only enables accurate collaborative prediction of the four types of pollutants in the flue gas, but also, based on the collaborative prediction model provided in some embodiments of this disclosure, couples multi-objective optimization to achieve effective intelligent control of the multiple pollutants. It ensures that the emission concentration of each of the multiple pollutants in waste incineration flue gas complies with national standards while minimizing the cost of absorbent dosage of the flue gas purification system to the greatest extent, thereby meeting both environmental protection and cost objectives. Compared to traditional methods that rely on CEMS equipment to monitor pollutant concentrations and manual adjustment of the flue gas purification system based on monitoring data, the method provided in some embodiments of the present disclosure offers significant advantages in speed, efficiency, accuracy, and collaboration. It avoids the latency associated with CEMS equipment while substantially reducing time and labor costs. Furthermore, by integrating the system for collaborative prediction and intelligent control of multiple pollutants in waste incineration flue gas in some embodiments of the present disclosure, the operational intelligence and cost-effectiveness of the incinerator can be greatly enhanced, enabling rapid and convenient control of each of the multiple pollutants in the flue gas.

Obviously, the foregoing descriptions are merely preferred embodiments of the present disclosure and are not intended to limit its scope. Those skilled in the art may make various subsequent applications, supplements, modifications, and variations to the present disclosure without departing from the spirit and scope of the present disclosure. If the various applications, supplements, modifications, and variations based on the present disclosure fall within the scope of the claims of the present disclosure and their equivalent technologies, the present disclosure is also intended to cover these applications, supplements, modifications, and variations.

What is claimed is:

1. A method for collaborative prediction and intelligent control of multiple pollutants in waste incineration flue gas, comprising:
S1, collecting all historical data of operating parameters of a waste incinerator and emission concentrations of flue gas pollutants at a set time interval within a same time period as collection samples to obtain incinerator operating parameter data and emission concentration data of the flue gas pollutants, wherein the incinerator operating parameter data is obtained from a storage database of a distributed control system (DCS) of the waste incinerator, the flue gas pollutants include four types of flue gas pollutants: hydrogen chloride (HCl), sulfur dioxide (SO₂), nitrogen oxides (NOₓ), and particulate matter (PM), and the emission concentration data of each type of the flue gas pollutants is obtained from a storage database of a continuous emission monitoring system (CEMS);
S2, for the operating parameters of the waste incinerator and the emission concentrations of the flue gas pollutants in the collection samples obtained in the step S1, calculating a Pearson correlation coefficient between the incinerator operating parameter data and the emission concentration data of each type of the flue gas pollutants; screening, based on the Pearson correlation coefficient between the incinerator operating parameter data and the emission concentration data of any one of the four types of flue gas pollutants, all the operating parameters of the waste incinerator in the collection samples, and retaining a screening result as input features for collaborative prediction training, wherein the emission concentration data of the four types of flue gas pollutants in the collection samples collected at a same time corresponding to the incinerator operating parameter data are used as data labels corresponding to the input features;
S3, performing mean down-sampling with a larger time span on data screened in the step S2; then selecting a part of the incinerator operating parameter data from the collection samples, performing time-series processing thereon to obtain processed data, and using the processed data as input data for training;
constructing a multi-pollutant collaborative prediction model based on a long short-term memory (LSTM) layer structure, inputting incinerator operating parameter data of a set time period to train the multi-pollutant collaborative prediction model, and using a collaborative prediction result corresponding to concentrations of the four types of flue gas pollutants after the set time period as an output of the multi-pollutant collaborative prediction model;
S4, absorbing and treating the four types of flue gas pollutants by a flue gas purification system using a corresponding absorbent, respectively; aiming at controlling a dosage of each absorbent corresponding to the four types of flue gas pollutants to construct a multi-objective optimization function F(x), wherein the multi-objective optimization function F(x) is generated based on two types of objective functions: a cost index function considering an absorbent dosage and an environmental protection index function considering pollutant emission amounts, a final optimization objective is to minimize a value of the multi-objective optimization function F(x), and input variables of the cost index function and the environmental protection index function both use a collaborative predicted concentration of flue gas multi-pollutants output by the multi-pollutant collaborative prediction model;
S5, setting a constraint condition for the multi-objective optimization function F(x) according to an actual dosage range of the each absorbent in engineering application and a limit standard of an emission concentration of each pollutant, using a multi-objective optimization algorithm to solve the multi-objective optimization function F(x), and calculating optimal dosage data of the each absorbent corresponding to the four types of flue gas pollutants, respectively, as a calculation result; and
S6, inputting the calculation result of the step S5 into the DCS of the waste incinerator, converting the optimal dosage data of the each absorbent corresponding to the four types of flue gas pollutants into an actual analog control signal, and then transmitting the actual analog control signal to a dispensing valve of the each absorbent in the flue gas purification system, wherein by controlling an opening degree of the dispensing valve of the each absorbent, feedback regulation of the dosage of the each absorbent is achieved, ensuring that the flue gas pollutants meet environmental emission standards while reducing the absorbent dosage, thereby achieving a cost-economic objective of the flue gas purification system.

2. The method according to claim 1, wherein in the step S2, selecting operating parameters of the waste incinerator with an absolute value of the Pearson correlation coefficient with the emission concentration data of any one of the four types of the flue gas pollutants greater than 0.3, using a part of the operating parameters of the waste incinerator as the input features of the multi-pollutant collaborative prediction model, and discarding the rest of the operating parameters of the waste incinerator.

3. The method according to claim 1, wherein the set time interval for data collection in the step S1 is 1 second, and mean down-sampling with a 5-minute interval is performed on the data screened in the step S2; for a prediction target of each sample after the mean down-sampling, the incinerator operating parameter data of first 12 samples of the collection samples are used as the input features of the multi-pollutant collaborative prediction model.

4. The method according to claim 1, wherein in the step S3, the multi-pollutant collaborative prediction model has 2 LSTM layers and 1 Dense layer, wherein a count of neurons in the Dense layer is 4, an input time step is 12, an output prediction step is 1, an optimizer is adaptive moment estimation (Adam), a loss function is mean squared error (MSE), and a maximum count of iterations is set to 100; and wherein a count of neurons in each LSTM layer, a type of activation function, and a learning rate are used as hyperparameters of the multi-pollutant collaborative prediction model, and an optimal parameter is determined by using a grid search manner.

5. The method according to claim 1, wherein in the step S4, absorbents corresponding to absorbing and treating the four types of flue gas pollutants HCl, SO₂, NOₓ, and PM are hydrated lime, sodium hydroxide, ammonia water, and activated carbon, respectively.

6. The method according to claim 1, wherein in the step S4, an expression of the multi-objective optimization function F(x) is as follows:
$$min F ( x ) = [ {f}_{1} ( x ) , {f}_{2} ( x ) , {f}_{3} ( x ) , {f}_{4} ( x ) , {g}_{1} ( x ) , {g}_{2} ( x ) , {g}_{3} ( x ) , {g}_{4} ( x ) ] ,$$
where f(x) is the cost index function indicating the absorbent dosage, g(x) is the environmental protection index function, and subscripts 1, 2, 3, and 4 denote the four types of flue gas pollutants HCl, SO₂, NOₓ, and PM, respectively;
the cost index function f(x) is represented by the following formula:
$$f ( x ) = ( {C}_{i n} - {C}_{o u t} ) \times V \times \frac{{M}_{A b s}}{{M}_{P}} \times η ,$$
where f(x) indicates the absorbent dosage; Cᵢₙ is an inlet flue gas pollutant concentration of the flue gas purification system; Cₒᵤₜ is the collaborative predicted concentration of the flue gas pollutants; V is a flue gas flow rate; M_{Abs} is a molecular molar mass of a main reaction component of the absorbent; M_{P} is a molecular molar mass of a main component of a certain type of pollutant; and η is an actual pollutant removal efficiency;
the environmental protection index function g(x) is represented by the following formula:
$$g ( x ) = f ( Q ) ,$$
where g(x) is a pollutant concentration; f is the multi-pollutant collaborative prediction model; Q is the absorbent dosage, which is a controllable variable.

7. The method according to claim 1, wherein in the step S5, the multi-objective optimization algorithm is a particle swarm optimization algorithm, an algorithm model corresponding to the particle swarm optimization algorithm is constructed by calling a pso function in a pyswarm library, a count of particles is set to 10, and a maximum count of iterations is 10.

8. The method according to claim 1, wherein in the step S6, the actual analog control signal is a current signal of 4˜20 mA; when the dosage of the absorbent to be controlled is 0%, the dispensing valve is fully closed, and a corresponding current signal is 4 mA; when the dosage of the absorbent to be controlled is 100%, the dispensing valve is fully open, and a corresponding current signal is 20 mA; and during transmission of the actual analog control signal, Modbus is used as a data communication protocol.

9. A system for collaborative prediction and intelligent control of multiple pollutants in waste incineration flue gas, comprising:
a waste incinerator distributed control system (DCS) module configured to collect and store real-time operating parameter data of a waste incinerator;
a flue gas continuous emission monitoring system (CEMS) module located at an end position of a flue of the waste incinerator and configured to collect and store real-time emission concentration data of four types of pollutants HCl, SO₂, NOₓ, and PM in a waste incineration flue gas;
a multi-pollutant collaborative prediction module configured to execute operations described in the steps S1 to S5 of claim 1, to achieve data processing, model training, outputting the collaborative predicted concentration of the flue gas multi-pollutants using the multi-pollutant collaborative prediction model, and calculating an optimal absorbent dosage; and
a multi-pollutant intelligent control module configured to execute operations described in the step S6 of claim 1, to issue control signals for the opening degree of the dispensing valve of the each absorbent in the flue gas purification system, and to reduce a flue gas purification cost of the flue gas purification system.
